(19) United States
(12) Patent Application Publication
(10) Pub. No.: US 2009/0055091 A1
(43) Pub. Date: Feb. 26, 2009

(54) Method, Apparatus, and Computer Program Product for Intelligently Selecting Between the Utilization of Geo-Fencing and Map Matching in a Telematics System

(76) Inventors: Jeffery Scott Hines, Wake Forest, NC (US); Timothy M. Wiwel, Raleigh, NC (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/844,399

(22) Filed: Aug. 24, 2007

(51) Int. Cl. G01C 21/00; G01S 5/00; G08B 1/08; H04Q 7/00

(52) U.S. Cl. 701/207; 340/539.13

(57) ABSTRACT

An enhanced mechanism for intelligently selecting between the utilization of geo-fencing and map matching in a telematics system. This geo-fencing/map matching selection mechanism determines for a use case at least one of a use case type and a telematics device location. If it is determined that the use case is a first use case type (e.g., fleet management) or the telematics device location is within a first region (e.g., a region without significant change), a geo-region map is utilized for geo-fencing. Otherwise, a vectorial map is utilized for map matching. Hence, in regions and/or use cases where detailed maps are not required, the geo-fencing/map matching selection mechanism can automatically utilize a geo-region map and thereby save on cost, both with regard to the cost of map licensing fees and the communications expenses necessary to provide detailed map updates to one or more telematics devices.

### BACKGROUND OF THE INVENTION

1. Field of Invention

The present invention relates in general to the digital data processing field and, in particular, to telematics systems. More particularly, the present invention relates to a mechanism for intelligently selecting between the utilization of geo-fencing and map matching in a telematics system.

2. Background Art

Businesses, governments and other organizations and entities often utilize one or more fleets of vehicles such as long-haul truck fleets, delivery truck fleets, emergency response vehicle fleets, utility vehicle fleets, maintenance vehicle fleets, taxi fleets, train fleets, aircraft fleets, ship fleets, and the like. Each vehicle in these fleets is subject to misuse or theft. For example, it is likely that some vehicles in such a fleet will be the target of thieves or used by employees at unauthorized times or along unauthorized routes. Moreover, the contents of a vehicle in such a fleet may be subject to misuse or theft, even if the vehicle itself is not misused or stolen. For example, one or more large shipping containers which are transported on trucks, trains and ships may be stolen from that vehicle. One way to reduce these problems is to install telematics devices in the vehicles of a fleet and/or in the shipping containers which are being transported on or in such vehicles. Such telematics devices can enable a fleet manager at a central monitoring station, for example, to monitor the location of the vehicles of the fleet and/or the shipping containers.

Global Positioning System (GPS) based “telematics systems” are increasingly being utilized to provide communications and function for fleet management and many other applications (also referred to herein as “use cases”). Examples of “use cases” include road usage charge (RUC), fleet management, vehicle tracking, excessive speed monitoring, navigation, and the like. In today's telematics implementations, each of these use cases utilizes either “geo-fencing” techniques or “map matching” techniques.

Formerly known as NAVSTAR, GPS was designed, funded and operated by the U.S. Department of Defense (DOD), although there are a myriad of civilian uses of GPS world-wide. In general, GPS is a satellite-based radio navigation system capable of determining continuous position and velocity information for an unlimited number of users. The nominal GPS Operation Constellation consists of twenty-four satellites that orbit the earth in twelve hours. There are often more than twenty-four operational satellites as new ones are launched to replace older satellites. Each satellite orbit is extremely precise and repeats almost the same ground track as the earth turns beneath the satellites once each day. Based on these precise orbits, GPS satellites can relay their location to any number of receiving units.

A device equipped to receive GPS data scans radio frequencies for signals from GPS satellites. Upon receiving such a satellite signal, the device can determine the precise location of the satellite via one of different conventional methods. The device will continue scanning for satellite signals until it has acquired at least three different satellite signals, each emanating from a different GPS satellite. The device utilizes the three known positions to determine its own two-dimensional position relative to the GPS satellites by implementing geometric triangulation. Additionally, the device may acquire a fourth satellite signal from a fourth GPS satellite to calculate its own three-dimensional position. The positioning and velocity data can be updated in real time on a continuous basis for an unlimited number of users.

Typically, in a location monitoring process, detailed map data are loaded into a memory of a telematics device. In the navigation use case, for example, the map data may be manipulated to provide route planning to a user of the telematics device. The telematics device may include a wireless communication mechanism that allows the map data to be received and updated from a server during a trip. The map data can include, for example, thoroughfare identifications, intersection identifications, altitude information, longitude information, latitude information, and the like. Using the map data, the device may, for example, display a portion of the data as a map to a user of the device, typically identifying the telematics device's location and orientation within the displayed map.

“Map matching” is a technology that provides location information based on a vectorial map containing road segments with specific information for a defined area, such as a country. For example, the process of plotting the device's present location within the map data, and mapping that location to the map is referred to as map matching or road locking. Map matching may also occur at a server that receives the telematics device's current location from the device via a wireless communication mechanism. Problems often occur with the map matching when the precise location of the telematics device at any particular moment in time and space is inaccurate, or when the map data contain slight inaccuracies. In some map matching processes, these inaccuracy problems are addressed by applying a correction to forcibly move the telematics device's current location to a closest road of the map data if the telematics device's current location is determined to be out of the road of the map data.

“Geo-fencing” is a technology that provides location information based on geographical zones. The technology determines in which geographical zone, out of a limited list of zones, the vehicle is located. Attributes can be defined for each zone. To simplify the location monitoring process, for example, a geo-fencing technique may be used to allow a fleet manager to establish one or more virtual boundaries around one or more predetermined locations. A series of virtual boundaries for each vehicle in the fleet may, for example, define a route along which that vehicle is authorized to follow. The use of such a geo-fencing technique may, for example, automatically notify the fleet manager if a vehicle and/or shipping container deviates from the authorized route.

In the case of geo-fencing, the localization is based on geographical zones instead of a road network as in the case of map matching. This advantageously reduces the amount of data required and the computing load for geo-fencing as compared to map matching, but at the cost of less accuracy. However, the accuracy of geo-fencing can be increased by adding more geographical zones. On the other hand, the amount of data required for map matching can also be reduced at the cost of less accuracy.

The maps used in map matching are typically large data files that are expensive to create and maintain. This expense relates to both the cost to buy or license the updated maps and the effort to provide the updated maps to the numerous telematics devices in the fleet. Map updates alone can drive most telematics business models into the red when one factors in both the cost of map licensing fees and the cost of updating the telematics devices (e.g., the communications expense such as cellular service charges necessary to provide the updated maps to each of the devices in the fleet).

Map licensing fees are generally related to the use of the map. Use-dependent map licensing fees are charged for uses such as mobile asset, routing, tracking, reverse geocoding, navigation, fleet optimization, etc. For example, simple tracking may have a unit cost of 1×, whereas navigation may have a unit cost of 30× and fleet optimization may have a unit cost (per vehicle) of 50×.

In some situations, map updates are desirable and their additional cost is justified. In other situations, however, map updates are less desirable and their additional cost cannot be justified. Within a region, for example, map updates may be critical in some areas (e.g., a few areas are changing fast) while map updates may not be critical in most of the areas (e.g., most areas are static). In another example, map updates may be critical to one use case while map updates may not critical to another use case. Also, for a number of use cases, such as fleet management, geo-fencing can be used to save on the cost of the large expensive maps.

Therefore, a need exists for an enhanced mechanism for intelligently selecting between the utilization of geo-fencing and map matching in a telematics system.

### SUMMARY OF THE INVENTION

According to the preferred embodiments of the present invention, an enhanced mechanism intelligently selects between the utilization of geo-fencing and map matching in a telematics system. This geo-fencing/map matching selection mechanism determines for a use case at least one of a use case type and a telematics device location. If it is determined that the use case is a first use case type (e.g., fleet management) or the telematics device location is within a first region (e.g., a region without significant change), a geo-region map is utilized for geo-fencing. Otherwise, a vectorial map is utilized for map matching. Hence, in regions and/or use cases where detailed maps are not required, the geo-fencing/map matching selection mechanism can automatically utilize a geo-region map and thereby save on cost, both with regard to the cost of map licensing fees and the communications expenses necessary to provide detailed map updates to one or more telematics devices.

The foregoing and other features and advantages of the invention will be apparent from the following more particular description of the preferred embodiments of the invention, as illustrated in the accompanying drawings.

### BRIEF DESCRIPTION OF THE DRAWINGS

The preferred exemplary embodiments of the present invention will hereinafter be described in conjunction with the appended drawings, where like designations denote like elements.

FIG. 1 is a block diagram of a telematics system for intelligently selecting between the utilization of geo-fencing and map matching in accordance with the preferred embodiments of the present invention.

FIG. 2 is a block diagram of a data center server for intelligently selecting between the utilization of geo-fencing and map matching in accordance with the preferred embodiments of the present invention.

FIG. 3 is an illustrative example of a geo-region map that incorporates a series of geo-fence objects that define a route on a geographical map in accordance with the preferred embodiments of the present invention.

FIG. 4 is a flow diagram illustrating a method for intelligently selecting between the utilization of geo-fencing and map matching in accordance with the preferred embodiments of the present invention.

### DETAILED DESCRIPTION OF THE PREFERRED EMBODIMENTS

### 1.0 Overview

In accordance with the preferred embodiments of the present invention, an enhanced mechanism intelligently selects between the utilization of geo-fencing and map matching in a telematics system. This geo-fencing/map matching selection mechanism determines for a use case at least one of a use case type and a telematics device location. If it is determined that the use case is a first use case type (e.g., fleet management) or the telematics device location is within a first region (e.g., a region without significant change), a geo-region map is utilized for geo-fencing. Otherwise, a vectorial map is utilized for map matching. Hence, in regions and/or use cases where detailed maps are not required, the geo-fencing/map matching selection mechanism can automatically utilize a geo-region map and thereby save on cost, both with regard to the cost of map licensing fees and the communications expenses necessary to provide detailed map updates to one or more telematics devices.

### 2.0 Detailed Description

Telematics systems (also referred to as Automatic Vehicle Location (AVL) systems), both terrestrial and satellite based, are increasingly being utilized to provide communications and function for many applications (also referred to herein as “use cases”). Exemplary use cases include fleet management, road usage charge (RUC), vehicle tracking, excessive speed monitoring, navigation, mobile asset, routing, tracking, reverse geocoding, fleet optimization, and the like. In conventional telematics implementations, each of these use cases utilizes either “geo-fencing” techniques or “map matching” techniques.

In accordance with the preferred embodiments of the present invention, a geo-fencing/map matching selection mechanism intelligently selects between the utilization of geo-fencing and map matching. Because both geo-fence data and map match data are used, the present invention makes it possible to reduce the cost and complexity of telematics use cases when a detailed map is not required for a particular use case and/or a particular region.

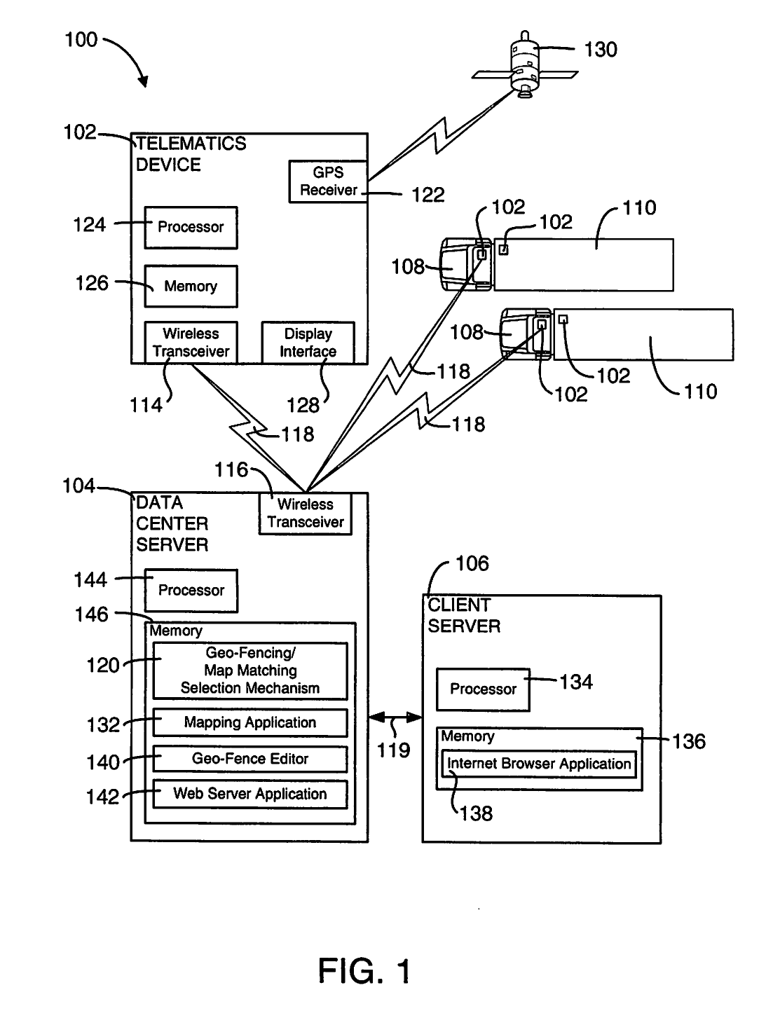

FIG. 1 is a block diagram of a telematics system 100 for intelligently selecting between the utilization of geo-fencing and map matching in accordance with the preferred embodiments of the present invention. More particularly, the telematics system 100 includes one or more telematics devices 102, a data center server 104, and a client server 106.

In accordance with the preferred embodiments of the present invention, at least one of the telematics devices 102 is installed in or on each asset to be tracked. For example, the telematics devices 102 may be installed on each vehicle (e.g., a cab 108 of a long-haul truck) in a fleet of vehicles, as well as on each shipping container (e.g., a trailer 110 of a long-haul truck) which is to be transported by those vehicles. In general, the telematics devices 102 may be carried in or on any item of interest, including people. For example, the telematics device 102 may be embodied in a portable device, such as PDA, cellular phone, iPhone, etc., carried in the pocket of a driver of a fleet vehicle.

A communications network is used to connect each of the telematics devices 102 to the data center server 104. In accordance with the preferred embodiments of the present invention, each of the telematics devices 102 includes a wireless transceiver 114 and the data center server 104 includes a wireless transceiver 116 that are used to connect the telematics devices 102 to the data center server 104 across a wireless network 118. The present invention applies equally no matter how the telematics devices 102 may be connected to the data center server 104, regardless of whether the network connection is made using present-day analog and/or digital techniques or via some networking mechanism of the future. The signals transmitted through the communications network between the telematics devices 102 and the data center server 104 include such signals as may be required or desired for one or more particular communications technologies. For example, the signals transmitted through the wireless network 118 may be adapted for use in two-way radio frequency (RF) communication technology (e.g., VHF, UHF, and the like) and/or cellular communication technology (e.g., time division multiple access (TDMA), frequency division multiple access (FDMA), code division multiple access (CDMA), global system for mobile communications (GSM), and the like). In accordance with the preferred embodiments of the present invention, these signals may be modulated, encrypted and/or compressed as desired for a given communications technology.

In accordance with the preferred embodiments of the present invention, the data center server 104 is connected to the client server 106 across a network 119. The present invention applies equally no matter how the client server 106 (if present) may be connected to the data center server 104, regardless of whether the network connection 119 is made using present-day analog and/or digital techniques or via some networking mechanism of the future. In addition, many different network protocols can be used to implement network 119. These protocols are specialized computer programs that allow computers to communicate across network 119. TCP/IP (Transmission Control Protocol/Internet Protocol) is an example of a suitable network protocol.

It may be desirable in some “use cases” for the telematics device 102 to be able to perform navigational tasks in a stand-alone fashion, at least temporarily, without requiring a continuous network connection to the data center server 104. Although the telematics device 102 may be capable of at least temporary independent operation, in accordance with the preferred embodiments of the present invention the telematics device 102 preferably receives information from the data center server 104 when a communication connection is available. The received information may include, for example, information for a current geographical region as well as information for a geographical region which the telematics device is predicted to enter in the future. More particularly, in accordance with the preferred embodiments of the present invention, the information for the current geographical region and/or predicted geographical region received by the telematics device 102 includes either a geo-region map for geo-fencing or a vectorial map containing road segments for map matching. As discussed in more detail below, the geo-fencing/map matching nature of the information transmitted from the data center server 104 to the telematics device 102 is selected by a geo-fencing/map matching selection mechanism 120 of the data center server 104 based on a determination of at least one of a use case type and a telematics device location.

In addition to the wireless transceiver 114, the telematics device 102 includes a GPS receiver 122, a processor 124, and a memory 126. It may be desirable in some use cases, such as navigation, for the telematics device 102 to include a display interface 128. Such a display interface 128 may used, for example, to connect one or more displays in the cab 108 of the long-haul truck to the telematics device 102 such that the driver of truck may view navigational information (e.g., map images and/or textual information) such as information transmitted from the data center server 104. The display interface 128 may also include an audio output through which audio prompts and navigation instructions can be presented.

The GPS receiver 122 is connected to an antenna (not shown) that receives signals from three or more GPS satellites, such as a satellite 130. The GPS receiver 122 scans radio frequencies for signals from GPS satellites. When the GPS receiver 122 receives such a satellite signal, the processor 124 determines the precise location of the satellite via one of different conventional methods. The GPS receiver 122 will continue scanning for satellite signals until it has acquired at least three different satellite signals, each emanating from a different GPS satellite. The processor 124 utilizes the three known positions to determine the two-dimensional position of the telematics device 102 relative to the GPS satellites by implementing geometric triangulation. Additionally, the GPS receiver 122 may acquire a fourth satellite signal from a fourth GPS satellite to permit the processor 124 to calculate the three-dimensional position of the telematics device 102. Preferably, the telematics device 102 updates the positioning and velocity data in real time on a continuous basis. Memory 126 is a local storage space in which navigational information, machine readable code, and the like may be stored.

Typically, the processor 124 produces a latitude, longitude, and altitude identifiers that use a standard coordinate system to determine the absolute location for the telematics device 102. In addition to the absolute location identifiers, or in lieu thereof, relative location identifiers may be determined by the processor 124 and used for navigation.

One of skilled in the art will appreciate that the present invention is not limited to telematics systems that utilize satellite based position determining systems. In one alternative embodiment, for example, the position of an item of interest may be determined using another type of locating system, such as a system of terrestrial towers that transmit signals to and/or receive signals from a receiver/transmitter located in or on the item of interest. Such a system can use propagation times between the item and the terrestrial towers to triangulate the item's position. This type of triangulation system can be implemented, for example, using a cellular telecommunications infrastructure or a Loran-C navigation system.

In an exemplary “navigation” use case, the telematics device 102 may generate navigation instructions based upon mapping data from the data center server 104, data from the GPS receiver 122, and conventional internal algorithms contained within the telematics device 102. The conventional internal algorithms used in this exemplary “navigation” use case may include, for example, a predictive algorithm to automatically obtain navigational information from the data center server 104 in advance of a need for this information. The mapping data received from the data center server 104 in this exemplary “navigation” use case may be in the form of a geo-region map for geo-fencing or a vectorial map containing road segment for map matching. The geo-fencing/map matching selection mechanism 120 may, for example, select which of these types of mapping data will be transmitted by the data center server 104 to the telematics device 102 based on the location of the telematics device 102. To accomplish this, the telematics device 102 transmits its location to the data center server 104. If the telematics device 102 is located in a static region (i.e. a region without significant change over a predetermined period of time, such as an interstate highway that has not recently undergone modification), the geo-fencing/map matching selection mechanism 120 may select mapping data in the form of a geo-region map for geo-fencing. On the other hand, if the telematics device 102 is located in non-static region (i.e., a region with significant change over a predetermined period of time, such as a growing suburban area), the geo-fencing/map matching selection mechanism 120 may select mapping data in the form of a vectorial map containing road segments for map matching.

In exemplary “fleet management” use case, the telematics device 102 may report vehicle route and schedule exceptions (e.g., the vehicle is off-course or aheadibehind schedule) to the data center server 104 based upon mapping data from the data center server 104, data from the GPS receiver 122, and conventional internal algorithms contained within the telematics device 102. The conventional internal algorithms used in this exemplary “fleet management” use case may include, for example, a vehicle route and schedule algorithm to automatically report the location of the vehicle to the data center server 104 if the vehicle deviates from a planned route and schedule and a predictive algorithm to automatically obtain navigational information from the data center server 104 in advance of a need for this information. The mapping data received from the data center server 104 in this exemplary “fleet management” use case may be in the form of a geo-region map for geo-fencing or a vectorial map containing road segment for map matching. The geo-fencing/map matching selection mechanism 120 may, for example, select which of these types of mapping data will be transmitted by the data center server 104 to the telematics device 102 based on a use case type. To accomplish this, the telematics device 102 transmits a use case type identifier to the data center server 104. If the use case type identifier received from telematics device 102 identifies a use case type that does not require detailed maps, the geo-fencing/map matching selection mechanism 120 may select mapping data in the form of a geo-region map for geo-fencing. On the other hand, if the use case type identifier received from the telematics device 102 identifies a use case type that does require detailed maps, the geo-fencing/map matching selection mechanism 120 may select mapping data in the form of a vectorial map containing road segments for map matching.

Also, in the exemplary “fleet management” use case, exception reports received by the data center server 104 from the telematics device 102 may be processed by a mapping application 132 of the data center server 104. The mapping application 132 may be executed at the data center server 104, itself, and/or remotely at the client server 106 as discussed in more detail below. Accordingly, the geo-fencing/map matching selection mechanism 120 may further select which type of mapping data will be used by the mapping application 132, at the data center server 104 and/or at the client server 106, based on the use case type of the mapping application 132 and/or the location of the telematics device 102.

The client server 106 includes a processor 134 and a memory 136. The memory 136 has stored therein, at least at various times, an internet browser application 138 providing the client server 106 the ability to remotely access data (e.g., mapping data) and applications (e.g., the mapping application 132 and/or a geo-fence editor 142) located at the data center server 104. For example, the internet browser application 138 (e.g., HTTP-based, HTTPS-based, etc.) may transfer files and data via a web server application 142 of the data center server 104. The user, once the mapping application 132 and/or the geo-fence editor 142 is/are accessed, can remotely execute the mapping application 132 and/or remotely create one or more geo-fence objects that can be associated with the telematics device 102 as boundaries for tracking the movements of the telematics device 102.

In addition to wireless transceiver 116, the data center server 104 includes a processor 144 and a memory 146. The memory 146 has stored therein, at least at various times, a plurality of functional applications including, for example, the geo-fencing/map matching selection mechanism 120, the mapping application 132, the geo-fence editor 140, and the web server application 142.

While the exemplary embodiments of the present invention illustrated herein show the various components of the data center server 104 co-located, one skilled in the art will appreciate that any of the various applications or components described above can be located on one or more servers or processors within a distributed network, such as a local area network, a wide area network, a telecommunications network, a dedicated network, an intranet and/or the internet, or within a dedicated secure or unsecured system. One skilled in the art will also appreciate that the various components can be combined into one or more devices or co-located on a particular node of a distributed network, such as a telecommunications network.

The web server application 142 may include any suitable web server programming that enables access and data exchange with the client server 106. For example, the web server application 142 may supply the mapping application 132 and/or geo-fence editor 140 in the form of an applet, plug-in, or the like for viewing and/or interaction by the user at the client server 106. Additionally, while exemplary embodiments of the present invention describe the client server 106 as including the internet browser application 138 and the data center server 104 as including the web server application 142, one of skilled in the art would recognize that any type of monolithic application could be employed, using suitable protocols, at both the data center server 104 and the client server 106, that would enable the user to obtain information from the data center server 104.

The mapping application 132 and the geo-fence editor 140 in accordance with the preferred embodiments of the present invention, may be employed by a user, at the data center server 104 and/or at the client server 106. The mapping application 132 and the geo-fence editor 140 may be separate components as shown in FIG. 1, or may be combined or omitted.

The mapping application 132 is conventional and provides communications and/or function for one or more use cases. The mapping application 132 may, for example, process the location of one or more of the telematics devices 102 for display on a map at the data center server 104 and/or the client server 106, or process exception reports received by the data center server 104 from one or more of the telematics devices 102 for display on a map at the data center server 104 and/or the client server 106.

The geo-fence editor 140 is conventional and provides the user with the ability to create geo-fence objects. A geo-fence object is one or more sets of boundaries used to monitor the telematics device 102. The geo-fence editor 140 provides geographical maps and locations with which the telematics device 102 may be tracked. The user can then create and edit one or more geo-fence objects in accordance with the user's desire. Once the geo-fence objects are created, the geo-fence editor 140 resolves the boundaries into a set of coordinates (e.g., longitude, latitude and altitude). The set of coordinates is next associated with a specific telematics device 102, to which the set of coordinates is forwarded for storage and use.

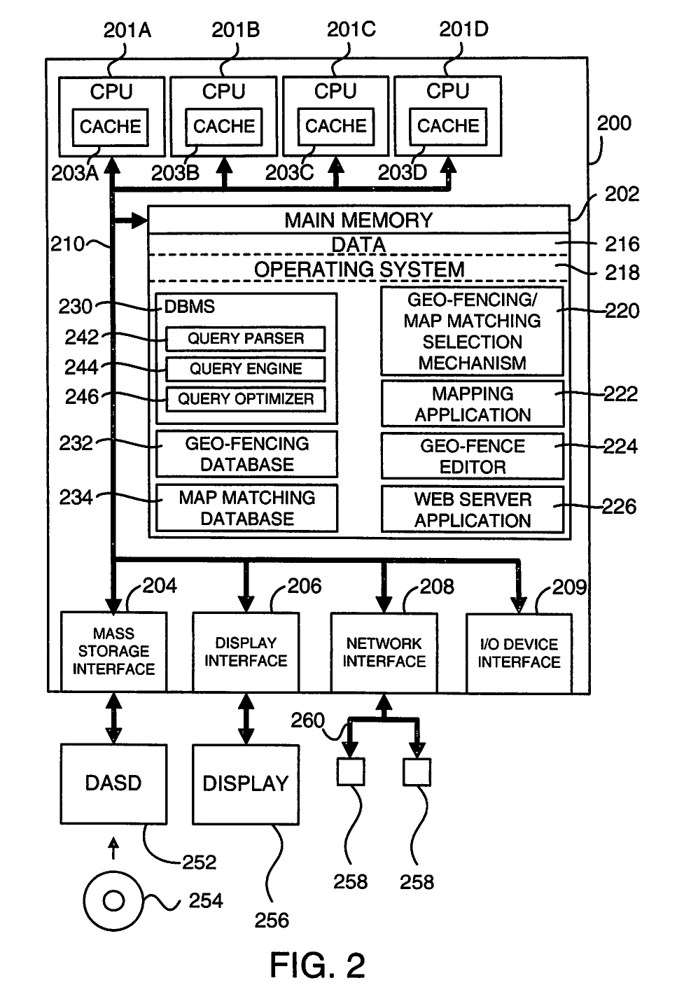

A computer system implementation of a data center server in accordance with the preferred embodiments of the present invention will now be described with reference to FIG. 2 in the context of a particular computer system 200, i.e., an IBM eServer iSeries or System i computer system. The computer system 200 shown in FIG. 2 is a computer system implementation of the data center server 104 shown in FIG. 1. Those skilled in the art will appreciate that the method, apparatus, and computer program product of the present invention apply equally to any computer system, regardless of whether the computer system is a complicated multi-user computing apparatus, a single user workstation, a PC, or an embedded control system. As shown in FIG. 2, computer system 200 comprises a one or more processors 201A, 201B, 201C and 201D, a main memory 202, a mass storage interface 204, a display interface 206, a network interface 208, and an I/O device interface 209. These system components are interconnected through the use of a system bus 210.

FIG. 2 is intended to depict the representative major components of computer system 200 at a high level, it being understood that individual components may have greater complexity than represented in FIG. 2, and that the number, type and configuration of such components may vary. For example, computer system 200 may contain a different number of processors than shown.

Processors 201A, 201B, 201C and 201D (also collectively referred to herein as “processors 201”) process instructions and data from main memory 202. Processors 201 temporarily hold instructions and data in a cache structure for more rapid access. In the embodiment shown in FIG. 2, the cache structure comprises caches 203A, 203B, 203C and 203D (also collectively referred to herein as “caches 203”) each associated with a respective one of processors 201A, 201B, 201C and 201D. For example, each of the caches 203 may include a separate internal level one instruction cache (L1 I-cache) and level one data cache (L1 D-cache), and level two cache (L2 cache) closely coupled to a respective one of processors 201. However, it should be understood that the cache structure may be different; that the number of levels and division of function in the cache may vary; and that the system might in fact have no cache at all.

Main memory 202 in accordance with the preferred embodiments contains data 216, an operating system 218 and application software, utilities and other types of software. The application software includes a geo-fencing/map matching selection mechanism 220, a mapping application 222, a geo-fence editor 224, and a web server application 226. These application software components respectively corresponds with the geo-fencing/map matching selection mechanism 120, the mapping application 132, the geo-fence editor 140, and the web server application 142 shown in FIG. 1. Because the mapping application 222, the geo-fence editor 224, and the web server application 226 are conventional, they are not discussed in detail at this point.

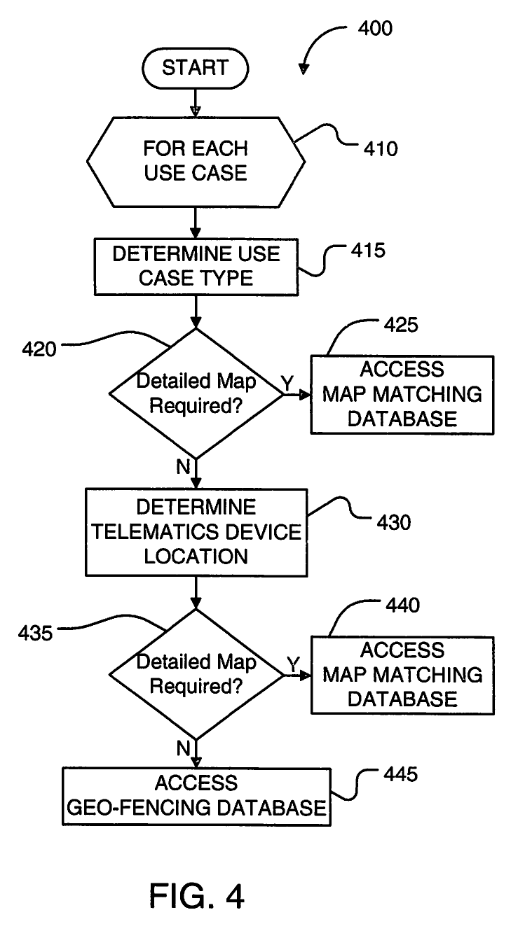

In the preferred embodiments of the present invention, the geo-fencing/map matching selection mechanism 220 includes instructions capable of executing on the processors 201 or statements capable of being interpreted by instructions executing on the processors 201 to perform the functions as further described below with reference to FIG. 4. In another embodiment, the geo-fencing/map matching selection mechanism 220 may be implemented in hardware via logic gates and/or other appropriate hardware techniques in lieu of, or in addition to, a processor-based system.

While the geo-fencing/map matching selection mechanism 220 is shown separate and discrete from the other software components (e.g., the mapping application 222 and the geo-fence editor 224) in FIG. 2, the preferred embodiments expressly extend to the geo-fencing/map matching selection mechanism being implemented within one or more of the other software components. In general, the geo-fencing/map matching selection mechanism may be implemented in the operating system 218 or application software, utilities, or other types of software within the scope of the preferred embodiments.

In addition, main memory 202 includes a database management system (DBMS) 230, a geo-fencing database 232, and a map matching database 234, each of which may in various embodiments exist in any number. The geo-fencing database 232 stores map data associated with a plurality of geo-region maps, as well as other data associated with each of the geo-region maps, such as whether or not the geo-region map depicts a static region, the cost of the geo-region map, the date the geo-region map was created, a measure of the effectiveness of the geo-region map, etc. These geo-region maps, for example, may have been created using the geo-fence editor 224, or may have been or are available for purchase and/or license from one or more third-party map vendors. The map matching database 234 stores map data associated with a plurality of vectorial maps containing road segments, as well as other data associated with each of the vectorial maps, such as whether or not the vectorial map depicts a static region, the cost of the vectorial map, the date the vectorial map was created, a measure of the effectiveness of the vectorial map, etc. These vectorial maps, for example, may have been or are available for purchase and/or license from one or more third-party map vendors. Although the DBMS 230, the geo-fencing database 232, and the map matching database 234 are illustrated as being contained within the main memory 202, in other embodiments some or all of them may be on different electronic devices (e.g., the geo-fencing database 232 and/or the map matching database 234 may be on the direct access storage device 252) and may be accessed remotely (e.g., the geo-fencing database 232 and/or the map matching database 234 may be on a direct access storage device at the facility of one or more third-party map vendors accessed via the network 260).

As is conventional, the DBMS 230 includes a query parser 242, a query engine 244, and a query optimizer 246. The query parser 242 is preferably implemented as computer program instructions that parse a structured query language (SQL) query. An SQL query is presented to the DBMS 230 in text form, the parameters of the SQL command. The query parser 242 retrieves the elements of the SQL query from the text form of the query and places them in a data structure more useful for data processing of an SQL query by the DBMS 230.

The query engine 244 performs a query against the geo-fence database 232 and/or the map matching database 234 using a query access plan that the query optimizer 246 creates. When the DBMS 230 receives a query, the DBMS 230 interprets the query and the query optimizer 246 determines what internal steps are necessary to satisfy the query. These internal steps may include identification of the table or tables specified in the query, the row or rows selected in the query, and other information such as whether to use an existing index, whether to build a temporary index, whether to use a temporary file to execute a sort, and/or the order in which the tables are to be joined together to satisfy the query. When taken together, these internal steps are typically referred to as a “query access plan” or “access plan” (AP).

As mentioned above, the query optimizer 246 creates the query access plan. The query optimizer 246 is preferably implemented as computer program instructions that optimize the access plan in dependence upon database management statistics. Database statistics may reveal, for example, that there are only two storelD values in the transactions table—so that it is an optimization, that is, more efficient, to scan the transactions table rather than using an index. Alternatively, database statistics may reveal that there are many transaction records with only a few transaction records for each storelD—so that it is an optimization, that is, more efficient, to access the transaction records by an index. When the query optimizer 246 creates an access plan for a given query, the access plan is saved by the DBMS 230, often in an access plan cache of the database. Then, when the user or a program object repeats the query, the database can reutilize the saved access plan instead of undergoing the time-consuming process of recreating it.

Computer system 200 utilizes well known virtual addressing mechanisms that allow the programs of computer system 200 to behave as if they have access to a large, single storage entity instead of access to multiple, smaller storage entities such as main memory 202 and DASD device 252. Therefore, while data 216, operating system 218, geo-fencing/map matching selection mechanism 220, mapping application 222, geo-fence editor 224, web server application 226, DBMS 230, geo-fencing database 232, and map matching database 234, are shown to reside in main memory 202, those skilled in the art will recognize that these items are not necessarily all completely contained in main memory 202 at the same time. It should also be noted that the term “memory” is used herein to generically refer to the entire virtual memory of the computer system 200.

Data 216 represents any data that serves as input to or output from any program in computer system 200. Operating system 218 is a multitasking operating system known in the industry as OS/400 or IBM i5/OS; however, those skilled in the art will appreciate that the spirit and scope of the present invention is not limited to any one operating system.

Processors 201 may be constructed from one or more microprocessors and/or integrated circuits. Processors 201 execute program instructions stored in main memory 202. Main memory 202 stores programs and data that may be accessed by processors 201. When computer system 200 starts up, processors 201 initially execute the program instructions that make up operating system 218. Operating system 218 is a sophisticated program that manages the resources of computer system 200. Some of these resources are processors 201, main memory 202, mass storage interface 204, display interface 206, network interface 208, I/O device interface 209 and system bus 210.

Although computer system 200 is shown to contain four processors and a single system bus, those skilled in the art will appreciate that the present invention may be practiced using a computer system that has a different number of processors and/or multiple buses. In addition, the interfaces that are used in the preferred embodiments each include separate, fully programmed microprocessors that are used to off-load compute-intensive processing from processors 201. However, those skilled in the art will appreciate that the present invention applies equally to computer systems that simply use I/O adapters to perform similar functions.

Mass storage interface 204 is used to connect mass storage devices (such as a direct access storage device 252) to computer system 200. One specific type of direct access storage device 252 is a readable and writable CD ROM drive, which may store data to and read data from a CD ROM 254.

Display interface 206 is used to directly connect one or more displays 256 to computer system 200. These displays 256, which may be non-intelligent (i.e., dumb) terminals or fully programmable workstations, are used to allow system administrators and users (also referred to herein as “operators”) to communicate with computer system 200. Note, however, that while display interface 206 is provided to support communication with one or more displays 256, computer system 200 does not necessarily require a display 256, because all needed interaction with users and processes may occur via network interface 208.

Network interface 208 is used to connect other computer systems (e.g., the telematics device 102 and/or the client server 106 shown in FIG. 1) and/or workstations 258 to computer system 200 across a network 260. The present invention applies equally no matter how computer system 200 may be connected to other computer systems and/or workstations, regardless of whether the network connection 260 is made using present-day analog and/or digital techniques or via some networking mechanism of the future. In addition, many different network protocols can be used to implement a network. These protocols are specialized computer programs that allow computers to communicate across network 260. TCP/IP (Transmission Control Protocol/Internet Protocol) is an example of a suitable network protocol.

The I/O device interface 209 provides an interface to any of various input/output devices (e.g., the wireless transceiver 116 shown in FIG. 1).

At this point, it is important to note that while this embodiment of the present invention has been and will be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD ROMs (e.g., CD ROM 254 of FIG. 2), and transmission type media such as digital and analog communications links (e.g., network 260 in FIG. 2).

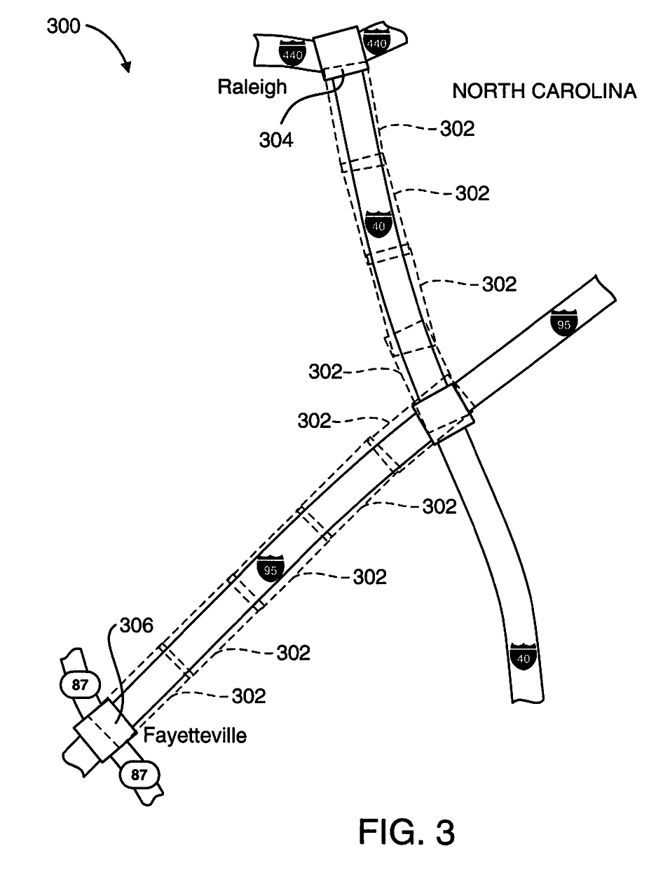

FIG. 3 is an illustrative example of a geo-region map 300 that incorporates a series of geo-fence objects 302 that define a route on a geographical map in accordance with the preferred embodiments of the present invention. While each geo-fence object 302 in the series of geo-fence objects 302 shown in FIG. 1 is rectangular, one skilled in the art will appreciate that the geo-fence objects may have any shape or shapes. Moreover, while the series of geo-fence objects 302 shown in FIG. 1 define a route along interstate highways between Raleigh, N.C. and Fayetteville, N.C., one skilled in the art will appreciate that the geo-fence objects may define any route along any geography between any starting point and any ending point. The route may be over land, over water, under water, through air, underground, and/or through space. Also, the geo-region map 300 need not include a series of geo-fence objects 302. For example, the geo-region map 300 may include a single geo-fence object.

In accordance with the preferred embodiments of the present invention, one or more geo-fence objects are defined on a geo-region map using, for example, the geo-fence editor 140. For example, a fleet dispatch manager using the geo-fence editor 140 at the data center server 104 or the client server 106 may identify a permissible route by defining a series of geo-fence objects 302 along a predetermined route (e.g., between Raleigh, N.C. and Fayetteville, N.C.). For example, the geo-region map 300 shown in FIG. 1 includes a series of overlapping rectangular geo-fence objects 302 that define a predetermined driving route from a starting point 304 in Raleigh, N.C. to an end point 306 in Fayetteville, N.C. Each rectangular geo-fence object 302 may be defined, for example, by the coordinates (e.g., GPS coordinates, latitude/longitude, and the like) of the rectangle's corners. Alternatively, in lieu using the geo-fence editor 140 to create the geo-region map 300, the geo-region map 300 may be obtained by purchasing it and/or licensing it from a third-party map vendor.

FIG. 4 is a flow diagram illustrating a method 400 for intelligently selecting between the utilization of geo-fencing and map matching in accordance with the preferred embodiments of the present invention. In the method 400, the steps discussed below (steps 410-445) are performed. These steps are set forth in their preferred order. It must be understood, however, that the various steps may occur at different times relative to one another than shown, or may occur simultaneously. Moreover, those skilled in the art will appreciate that one or more of the steps may be omitted. The method 400 begins with the geo-fencing/map matching selection mechanism receiving a request from a use case for mapping data (step 410). This request may be received from a use case in the telematics device, the data center server, or the client server. Method 400 continues with the geo-fencing/map matching selection mechanism determining the use case type of the use case that made the request (step 415). For example, the geo-fencing/map matching selection mechanism may receive a use case type identifier from the telematics device, the data center server, or the client server that identifies the use case type of the use case that made the request. The method 400 continues with the geo-fencing/map matching selection mechanism determining whether the use case type (i.e., previously determined in step 415) requires a detailed map (step 420). To accomplish this determination, the geo-fencing/map matching selection mechanism may, for example, utilize a lookup table that lists a plurality of use case types and for each use case type indicates whether or not that use case type requires a detailed map.

If the geo-fencing/map matching selection mechanism determines in step 420 that detailed maps are required by the use case that made the request, the method 400 continues with the geo-fencing/map matching selection mechanism causing the DBMS to access the map matching database (step 425). The DBMS then supplies a vectorial map that satisfies the use case's request for mapping data. In this regard, the geo-fencing/map matching selection mechanism preferably cooperates with the DBMS to utilize data in the map matching database that is associated with each of the vectorial maps, such as the cost of the vectorial map, a measure of the functional performance of the vectorial map, the date the vectorial map was created, whether or not the vectorial map depicts a static region, etc. This allows the geo-fencing/map matching selection mechanism to choose among several different vendors' maps so that the most effective vectorial map (e.g., on the basis of cost and/or a measure of functional performance) at any particular time can be supplied to satisfy the request from the use case.

On the other hand, if the geo-fencing/map matching selection mechanism determines in step 420 that detailed maps are not required by the use case that made the request, the method 400 continues with the geo-fencing/map matching selection mechanism determining the location of the telematics device associated with the use case that made the request (step 430). For example, the geo-fencing/map matching selection mechanism may receive coordinates (e.g., GPS coordinates, latitude/longitude, and the like) from the telematics device. The telematics device may, for example, transmit its location constantly, periodically, as a portion of an exception report, or in response to a request initiated by the geo-fencing/map matching selection mechanism. The method 400 continues with the geo-fencing/map matching selection mechanism determining whether the telematics device location (i.e., previously determined in step 430) is within a region that requires a detailed map (step 435). To accomplish this determination, the geo-fencing/map matching selection mechanism may, for example, utilize a lookup table that lists a plurality of regions and for each region whether or not that region requires a detailed map. The lookup table may, for example, identify static regions (i.e., regions that have not changed significantly over a predetermined period of time) that do not require detailed maps, and/or identify non-static regions (i.e., regions that have changed significantly over the predetermined period of time) that require detailed maps.

If the geo-fencing/map matching selection mechanism determines in step 435 that detailed maps are required by the region in which telematics device is located, the method 400 continues with the geo-fencing/map matching selection mechanism causing the DBMS to access the map matching database (step 440). The DBMS then supplies a vectorial map that satisfies the use case's request for mapping data. In this regard, the geo-fencing/map matching selection mechanism preferably cooperates with the DBMS to utilize data in the map matching database that is associated with each of the vectorial maps, such as the cost of the vectorial map, a measure of the functional performance of the vectorial map, the date the vectorial map was created, whether or not the vectorial map depicts a static region, etc. This allows the geo-fencing/map matching selection mechanism to choose among several different vendors' maps so that the most effective vectorial map (e.g., on the basis of cost and/or a measure of functional performance) at any particular time can be supplied to satisfy the use case's request for mapping data.

Otherwise, if the geo-fencing/map matching selection mechanism determines in step 435 that detailed maps are not required by the region in which telematics device is located, the method 400 continues with the geo-fencing/map matching selection mechanism causing the DBMS to access the geo-fencing database (step 445). The DBMS then supplies a geo-region map that satisfies the use case's request for mapping data. In this regard, the geo-fencing/map matching selection mechanism preferably cooperates with the DBMS to utilize data in the geo-fencing database that is associated with each of the geo-region maps, such as the cost of the geo-region map, a measure of the functional performance of the geo-region map, the date the geo-region map was created, whether or not the geo-region map depicts a static region, etc. This allows the geo-fencing/map matching selection mechanism to choose among maps created by the geo-fence editor and/or several different vendors' maps so that the most effective geo-region map (e.g., on the basis of cost and/or a measure of functional performance) at any particular time can be supplied to satisfy the use case's request for mapping data.

During the performance of the method 400, therefore, the geo-fencing/map matching selection mechanism in accordance with the preferred embodiments of the present invention utilizes a two-tiered lookup for selecting the mapping data to fulfill the use case's request for mapping data.

The present invention can be used to provide various benefits such as to lower the cost of map updates by using geo-fencing in areas where detailed maps are not required, as well as to increase the frequency of map updates for critical areas. Among the key benefits that can be achieved in accordance with the preferred embodiments of the present invention are the savings in map update costs, as well as the reduced system resources required to store and update the maps. Generally, those suppliers in telematics industry that can control and manage communications cost and map update cost will have the function/cost advantage in the market. The present invention can be a useful tool in achieving that function/cost advantage.

One skilled in the art will appreciate that many variations are possible within the scope of the present invention. Thus, while the present invention has been particularly shown and described with reference to preferred embodiments thereof, it will be understood by those skilled in the art that changes in form and details may be made therein without departing from the spirit and scope of the present invention.

What is claimed is:

1. A computer-implemented method for intelligently selecting between the utilization of geo-fencing and map matching in a telematics system, comprising the steps of:
determining for a use case at least one of a use case type and a telematics device location;
if it is determined that the use case is a first use case type or the telematics device location is within a first region, utilizing a geo-region map for geo-fencing;
if it is determined that the use case is not the first use case type or the telematics device location is not within the first region, utilizing a vectorial map for map matching.

2. The computer-implemented method as recited in claim 1, wherein the first use case type comprises fleet management.

3. The computer-implemented method as recited in claim 1, wherein the first region is a substantially static region.

4. The computer-implemented method as recited in claim 1, wherein the step of utilizing a vectorial map for map matching includes the step of selecting between a plurality of vectorial maps based on at least one predetermined criteria.

5. The computer-implemented method as recited in claim 4, wherein the at least one predetermined criteria includes the cost of each of the plurality of vectorial maps.

6. A telematics system, comprising:
a processor;
a memory coupled via a bus to the processor, the memory including a geo-fencing/map matching selection mechanism comprising instructions that when executed by the processor comprise the steps of:
determining for a use case at least one of a use case type and a telematics device location;
if it is determined that the use case is a first use case type or the telematics device location is within a first region, utilizing a geo-region map for geo-fencing;
if it is determined that the use case is not the first use case type or the telematics device location is not within the first region, utilizing a vectorial map for map matching.

7. The telematics system as recited in claim 6, further comprising:
a data center server that includes the processor and the memory;
a telematics device equipped to receive GPS data;
wherein the data center server and the telematics device are configured to enable wireless communication therebetween, and wherein the telematics device location is transmitted from the telematics device to the data center server and either the geo-region map or the vectorial map is transmitted from the data center server to the telematics device.

8. The telematics system as recited in claim 7, wherein the telematics device is mounted to at least one of a vehicle or to a shipping container to be transported by a vehicle.

9. The telematics system as recited in claim 8, wherein the data center server includes a geo-fence editor application comprising instructions that when executed enable the creation of one or more geo-fence objects on a geographical map to define the geo-region map.

10. The telematics system as recited in claim 9, further comprising:
a client server connected to the data center server over a network, wherein a network server application in the data center server provides the geo-fence editor application to the client server for enabling a user to remotely create one or more geo-fence objects on a geographical map to define the geo-region map, and wherein a browser application in the client server transfers the remotely created geo-region map to the data center server.

11. The telematics system as recited in claim 6, wherein the first use case type comprises fleet management.

12. The telematics system as recited in claim 6, wherein the first region is a substantially static region.

13. The telematics system as recited in claim 6, wherein the geo-fencing/map matching selection mechanism comprises instructions that when executed by the processor comprise the step of:
if it is determined that the use case is not the first use case type and the telematics device location is not within a first region, selecting between a plurality of vectorial maps based on at least one predetermined criteria.

14. The telematics system as recited in claim 13, wherein the at least one predetermined criteria includes the cost of each of the plurality of vectorial maps.

15. A computer program product for intelligently selecting between the utilization of geo-fencing and map matching in a digital computing device of a telematics system, wherein the digital computing device has at least one processor, comprising:
a plurality of executable instructions provided on computer readable signal bearing media, wherein the executable instructions, when executed by the at least one processor, cause the digital computing device to perform the steps of:
determining for a use case at least one of a use case type and a telematics device location;
if it is determined that the use case is a first use case type or the telematics device location is within a first region, utilizing a geo-region map for geo-fencing;
if it is determined that the use case is not the first use case type or the telematics device location is not within the first region, utilizing a vectorial map for map matching.

16. The computer program product as recited in claim 15, wherein the signal bearing media comprises recordable media.

17. The computer program product as recited in claim 15, wherein the signal bearing media comprises transmission media.

18. The computer program product as recited in claim 15, wherein the first use case type comprises fleet management.

19. The computer program product as recited in claim 18, the first region is a substantially static region.

20. The computer program product as recited in claim 15, wherein the step of utilizing a vectorial map for map matching includes the step of selecting between a plurality of vectorial maps based on at least one predetermined criteria, and wherein the at least one predetermined criteria includes the cost of each of the plurality of vectorial maps.
